(19) United States
(12) Patent Application Publication
(10) Pub. No.: US 2016/0009855 A1
(43) Pub. Date: Jan. 14, 2016

(54) METHOD FOR PERFORMING MECHANICAL, CHEMICAL AND/OR THERMAL PROCESSES

(71) Applicant: LIST HOLDING AG, Arisdorf (CH)

(72) Inventor: Daniel Witte, Grenzach-Wyhlen (DE)

(21) Appl. No.: 14/377,635

(22) PCT Filed: Feb. 8, 2013
(86) PCT No.: PCT/EP2013/052498

§ 371 Date: Aug. 8, 2014

(30) Foreign Application Priority Data
Feb. 10, 2012 (DE) 10 2012 101 087.0
Oct. 24, 2012 (DE) 10 2012 110 118.3

(51) Int. Cl. C08G 63/08

(52) U.S. Cl. CPC C08G 63/08

(57) ABSTRACT

In a method for performing a reaction in a housing that has at least one feed point, at least one catalyst is mixed into the reactant, as a result of which the product reacts up to a desired degree of conversion.

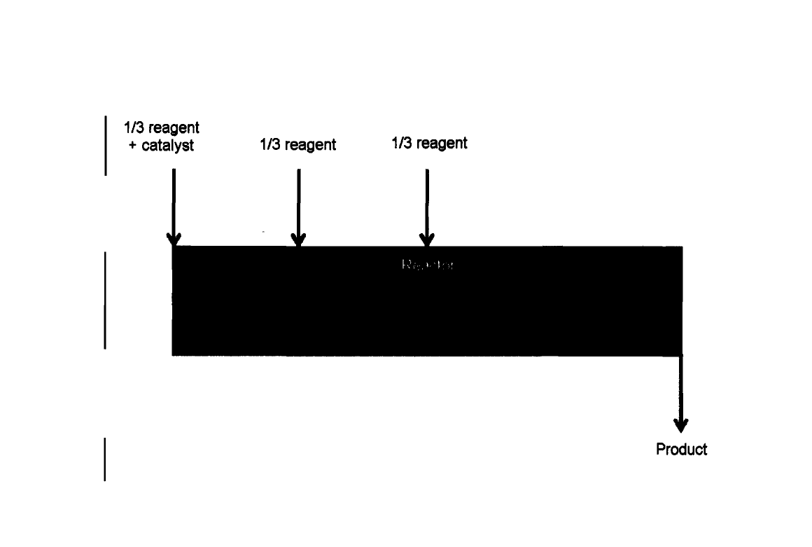

### BACKGROUND OF THE INVENTION

In a method for performing mechanical, chemical and/or thermal processes in a reagent and/or product in a housing which has at least one feed point, where at least one catalyst is mixed into the reagent, as a result of which the product undergoes reaction up to a desired degree of conversion.

Such devices are performed, for example, in mixer-kneaders. These serve highly diverse purposes. The first which may be mentioned is evaporation with solvent recovery, which proceeds batchwise or continuously and also frequently under vacuum. For example distillation residues, and in particular toluene diisocyanates, are treated hereby, but also production residues having toxic or high-boiling solvents from the chemical industry and pharmaceutical production, wash solutions and paint sludges, polymer solutions, elastomer solutions from solvent polymerization, adhesives and sealing compounds.

Using the apparatuses, in addition, a continuous or batchwise contact drying of water-moist and/or solvent-moist products, frequently likewise under vacuum, is performed. The application is conceived, primarily, for pigments, dyes, fine chemicals, additives such as salts, oxides, hydroxides, antioxidants, temperature-sensitive pharmaceutical and vitamin products, active ingredients, polymers, synthetic rubbers, polymer suspensions, latex, hydrogels, waxes, pesticides and residues from chemical or pharmaceutical production, such as salts, catalysts, slags, waste liquors. These methods are also used in food production, for example in production and/or treatment of sweetened condensed milk, sugar replacers, starch derivatives, alginates, for the treatment of industrial sludges, oil sludges, biosludges, paper sludges, paint sludges and generally for treatment of sticky, crust-forming viscous-pasty products, waste products and cellulose derivatives.

In a mixer-kneader, a polycondensation reaction can take place, usually continuously, and usually in the melt, and is used primarily in the treatment of polyamides, polyesters, polyacetates, polyimides, thermoplastics, elastomers, silicones, urea resins, phenol resins, detergents and fertilizers. For example, they are applied to polymer melts after a bulk polymerization of derivatives of methacrylic acid.

A polymerization reaction can also take place, likewise usually continuously. This is applied to polyacrylates, hydrogels, polyols, thermoplastic polymers, elastomers, syndiotactic polystyrene and polyacrylamides.

In mixer-kneaders, degassing and/or devolatilization can take place. This is employed on polymer melts, after (co-) polymerization of monomer(s), after condensation of polyester or polyamide melts, on spinning solutions for synthetic fibers and on polymer or elastomer granules and/or powders in the solid state.

Quite generally, solid, liquid or multi-phase reactions can take place in the mixer-kneader. This applies, primarily, to back reactions, in the treatment of hydrofluoric acid, stearates, cyanides, polyphosphates, cyanuric acids, cellulose derivatives, cellulose esters, cellulose ethers, polyacetal resins, sulfanilic acids, Cu-phthalocyanins, starch derivatives, ammonium polyphosphates, sulfonates, pesticides and fertilizers.

In addition, reactions can take place in the solid/gaseous state (e.g. carboxylation) or liquid/gaseous state. This is employed in the treatment of acetates, acids, Kolbe-Schmitt reactions, e.g. BON, Na-salicylates, parahydroxybenzoates and pharmaceutical products.

Liquid/liquid reactions proceed in neutralization reactions and transesterification reactions.

A dissolution and/or degassing in such mixer-kneaders takes place in spinning solutions for synthetic fibers, polyamides, polyesters and celluloses.

What is termed flushing takes place in the treatment and/or production of pigments.

A solid-state post-condensation takes place in the production and/or treatment of polyesters, polycarbonates and polyamides, a continuous pulping, e.g. in the treatment of fibers, e.g. cellulose fibers, with solvents, a crystallization from the melt or from solutions in the treatment of salts, fine chemicals, polyols, alcoholates, compounding, mixing (continuous and/or batchwise) in polymer mixtures, silicone compounds, sealing compounds, fly ash, a coagulation (in particular continuous) in the treatment of polymer suspensions.

In a mixer-kneader, multifunctional processes can also be combined, for example heating, drying, melting, crystallization, mixing, degassing, reacting - all of this continuous or batchwise. Polymers, elastomers, inorganic products, residues, pharmaceutical products, food products, printing inks can be produced and/or treated thereby.

In mixer-kneaders, a vacuum sublimation/desublimation can also take place, as a result of which chemical precursors, e.g. anthraquinone, metal chlorides, ferrocenes, iodine, organometallic compounds, etc., are purified. In addition, pharmaceutical intermediates can be produced.

A continuous carrier gas desublimation takes place, e.g., in organic intermediate products, e.g. anthraquinone and fine chemicals.

Single-shaft and two-shaft mixer-kneaders differ substantially. A single-shaft mixer-kneader is known, for example, from AT 334 328, CH 658 798 A5, or CH 686 406 A5. In these cases, an axially extending shaft rotating about an axis of rotation in one direction of rotation and fitted with disk elements is arranged in a housing. This shaft effects the transport of the product in the transport direction. Between the disk elements, counter elements are mounted so as to be stationary on the housing. The disk elements are arranged in planes perpendicular to the kneader shaft, and form free sectors between them which form kneading spaces with the planes of adjacent disk elements.

A multishaft mixer- and kneader machine is described in CH-A 506 322. There, radial disk elements are situated on a shaft and axially oriented kneading bars are arranged between the disks. Frame-like shaped mixing- and kneading-elements of the other shaft engage between said disks. These mixing- and kneading elements clean the disks and kneading bars of the first shaft. The kneading bars on both shafts in turn clean the housing inner wall.

A mixer-kneader of the abovementioned type is known, for example, from EP 0 517 068 B1. Therein, two axially parallel shafts either co-rotate or counter-rotate in a mixer housing. In this case, mixing bars mounted on disk elements interact with one another. In addition to the function of mixing, the mixing bars have the task of cleaning product-contact surfaces of the mixer housing, the shafts and the disk elements as well as possible, and to thereby avoid unmixed areas.

In addition, a mixer-kneader of the abovementioned type is known from DE 199 40 521 A1, in which the support elements form a recess in the region of the kneading bars, in order that an axial extension as large as possible is presented to the kneading bars. Such a mixer-kneader has outstanding self-cleaning of all product-contact surfaces of the housing and of the shafts, but has the property that the support elements of the kneading bars make recesses necessary owing to the paths of the kneading bars, which recesses lead to complicated support element shapes.

### SUMMARY OF THE INVENTION

The problem addressed by the present invention is to improve the reaction process in the reagent and/or in the product. In addition, a reaction process is to be provided in which as little catalyst as possible is consumed without the reaction rate being greatly decreased.

### BRIEF DESCRIPTION OF THE DRAWINGS

The accompanying drawing is a graphical depiction of the method according to the invention.

### DETAILED DESCRIPTION

Mixing the reagent with the catalyst prior to introduction into the housing leads to the solution to the problem.

The method which is the subject matter of this invention shall be based on a catalytic reaction, wherein the conversion and therefore the necessary size of the reactor and/or the residence time of a mixture of reagent and product in the reactor depends on the concentration of catalyst in the mixture of reagent and product of the reaction. The reagent and the product should, as should also the catalyst, be readily miscible with one another, or better still, soluble in one another.

It is, primarily, a method for the catalytic polymerization or reaction of monomers or other starting materials with increased conversion. It shall be a reaction in which no intermediate products are formed, or are formed only for a brief time. As an example, mention may be made of the polymerization of polylactides (PLAs), which is performed by catalytic ring-opening polymerization of lactides.

It is typical of this reaction that the monomer is intensively premixed with the catalyst and is then fed to a polymerization reactor. The polymerization reactor is typically continuous, since the end product is viscous and therefore poorly flowable. Therefore, horizontal mixer-kneaders, screw extruders, stirred tanks or ring reactors with static mixers are used. All of these reactor types have in common the fact that during the polymerization mixing of the polymer with the catalyst and the monomer must be ensured. Only in this manner is it possible to produce high-molecular-weight PLA. Whereas the reactor types differ with respect to the possibility of achieving high degrees of conversion, they have in common the fact that the reaction rate depends, in a first approximation, linearly on the catalyst concentration. Unfortunately, the fact is that the best catalysts have a zinc basis, wherein toxic breakdown products can be formed. The concentration of catalyst must therefore be limited, wherein, then, the reaction time increases, however. As a result, unwanted side reactions equally have more time to develop, which leads to an impairment of product properties. These side reactions can be counteracted by lowering the temperature, which, however, further lowers the reaction rate.

The method according to the invention improves the limitations mentioned, in that the catalyst is mixed with a subquantity of the reagent and is then fed to the polymerization reactor. Since, now, the catalyst concentration is higher, the reaction rate is also correspondingly higher. The substantially exhaustively reacted product is mixed with a further subquantity of reagent. The reaction velocity is then lower. This process is repeated until the entire amount of reagent has been mixed in and exhaustively reacted. The concentration of catalyst is therefore identical to the event that the reagent was completely mixed in advance with catalyst, but the reaction was faster at the start.

If this concept of the method is transferred to a continuous process, the advantages become really visible. In the continuous method, the completely available reactor volume is always utilized. Since the required residence time of the first feed point, however, is shorter, the distance from the second feed point can be decreased. Similarly, this also applies to the feed points following. An example which may be mentioned is that the reaction is of first order and is linearly dependent on the catalyst concentration. Then, the required residence time is tripled if the amount of catalyst is reduced by the factor three. If, however, the feed is distributed among three identical feed points, at a spacing of 25% between feed points 1 and 2, and also of 25% between feed points 2 and 3, this gives an increase in the required residence time only by 35% (instead of 200%).

If the continuous process is partially back-mixed over the length, a further advantage of the method according to the invention results in that the back-mixed region can be set by each individual feed point separately with respect to degree of conversion and temperature level. Many reactions are exothermic and therefore need an exact temperature profile. In the back-mixed method, the temperature level is set during start-up of the process and is then maintained via the energy balance. If only one feed point is present, also only one temperature level can be adjusted. The part of the reactor downstream which is not sufficiently back-mixed with the region of the feed receives its charge with reagent and product from the preceding back-mixed apparatus part, and therefore may not be adjusted independently. In the case of a plurality of feed points, by controlling the other feed points in terms of time and amount, the degree of conversion and the temperature level can be adjusted over the complete reactor space. Separate protection is also sought therefor.

Partially back-mixed reactors are e.g. high-volume, horizontal kneaders, wherein mixing in the shaft direction is impeded by corresponding internals on the shaft or the housing. These apparatuses have good radial and tangential mixing action. The product flow and therefore the orientation of the back-mixing is therefore achieved in the shaft direction.

1-10. (canceled)

11. A method for feeding a reagent and a catalyst to a reaction zone comprising the steps of:
providing a reaction zone;
feeding an amount of catalyst to the reaction zone with a first amount of reagent; and
thereafter adding, in one or more subsequent steps at different time intervals, additional reagent to the reaction zone.

12. The method as claimed in claim 11, wherein the first amount of reagent is mixed with the catalyst before addition into the reaction zone.

13. The method as claimed in claim 11, wherein the additional reagent is added to the reaction zone at separate feed points which are spatially separated.

14. The method as claimed in claim 13, wherein a back mixing is impeded by providing internals on a shaft or a housing of the reaction zone between the separate feed points.

15. The method as claimed in claim 11, including adding an initiator to the reaction zone to initiate the reaction.
